(19) United States
(12) Patent Application Publication
(10) Pub. No.: US 2011/0032843 A1
(43) Pub. Date: Feb. 10, 2011

(54) SETTING UP A VIRTUAL PRIVATE NETWORK USING VIRTUAL LAN IDENTIFIERS

(76) Inventors: Oktavian Papp, Tinnye (HU); András Császár, Budapest (HU); Attila Mihály, Dunakeszi (HU); Lars Westberg, Enkoping (SE); Gabor Toth, Szigetszentmiklos (HU)

Correspondence Address: ERICSSON INC., 6300 LEGACY DRIVE, M/S EVR 1-C-11, PLANO, TX, 75024, US

(21) Appl. No.: 12/936,972

(22) PCT Filed: Apr. 10, 2008
(86) PCT No.: PCT/EP08/54337

§ 371 Date: Oct. 8, 2010

(51) Int. Cl. H04L 12/28

(52) U.S. Cl. 370/254

(57) ABSTRACT

A method for setting up a VPN is described. The VPN is set up in a backbone network having a plurality of PE routers for controlling the transfer of IP traffic to and from CE routers in satellite networks. In a PE router, a VRF is configured for the VPN and populated with local routes for the VPN. A VLAN identifier is assigned for the VPN, and advertised to other PE routers in the backbone network. Alternatively, the VLAN identifier may be determined by a predetermined mapping algorithm so it will be unique to the VPN in all PE routers, in which case the advertisement to other PE routers may contain an implicit NULL label.

### TECHNICAL FIELD

The present invention relates to a method and apparatus for setting up a virtual private network. In particular, the apparatus relates to a method for providing routing and addressing information in virtual private networks.

### BACKGROUND

Many enterprises operate from a number of different locations. They may have networks such as Local Area Networks (LANs) operating at each location. It is often desirable for such enterprises to interconnect these “satellite” networks so that all users can access resources from all of the satellite networks. To such users, it would appear that the enterprise operates a single network incorporating all of the satellite networks.

This can be facilitated by the use of a Virtual Private Network (VPN). A VPN is a communications network “tunnelled” through another network. One common application is secure communications through the public Internet, but many other applications can be envisaged.

Different VPN service models have been proposed over the last several years in order to satisfy diverse requirements. These models include traditional Frame Relay or Asynchronous Transfer Mode (ATM) VPNs; customer equipment based VPNs, such as those using Layer 2 Tunnelling Protocol (L2TP) and/or IP Security (IPSec); and provider provisioned VPNs (Layer 2 (L2) and Layer 3 (L3) VPNs). In the provider provisioned network based L3 VPNs, Provider Edge (PE) routers contain the VPN functionality needed to transfer L3 (IP) traffic between different sites of a customer.

L3VPN technology has many potential uses, including in the Internet. Furthermore, the 3rd Generation Partnership Project (3GPP) is discussing a Long Term Evolution (LTE) wireless communication standard, in which the core network architecture is known as System Architecture Evolution (SAE). The backbone networks for this architecture may well be IP-based, and it can be envisaged that VPNs may be required for applications such as core network nodes for signalling or Operations, Administration and Maintenance (OAM) traffic; base stations for radio signalling or OAM traffic; base stations, SAE Gateways (GWs) and Mobility Management Entities (MMEs) within the same pool; all non-3GPP serving nodes; fixed access edge routers; and Video on Demand (VoD) servers and clients.

FIG. 1 depicts a general schematic view of a PE-based, provider provisioned L3 VPN architecture. Four LANs 11-14 are connected to a provider's IP network (backbone network) 15. Two of the LANs 11, 12 belong to a first customer, and are linked to provide a first VPN. The other two LANs 13, 14 belong to a second customer, and are linked to form a second VPN. Each LAN includes a Customer Edge (CE) router CE1-CE4. The backbone network 15 includes two PE routers PE1, PE2, to which the CE routers CE1-CE4 are connected. The backbone network further includes Provider (P) routers P1-P5 that forward data (including VPN data), but which do not provide VPN functionality to the CE routers CE1-CE4.

An IP packet 16 is sent from a source node (not shown) within a LAN 11 belonging to the first customer, and is intended for a destination node (also not shown) within the other LAN 12 of that customer. The packet 16 contains an IP payload 17 and destination IP address information 18. The packet 16 is sent from the CE router CE1 at the edge of the LAN 11 to an “ingress” PE router PE1. The package is encapsulated, and inner and outer headers 19, 20 added, to route it, via P routers P1, P2, to an egress PE router PE2. At the egress router PE2 the inner and outer headers 19, 20 are removed. The packet is then forwarded to the CE router CE 2 at the edge of the second LAN 12, and on from there to the destination node within the second LAN.

Two provider-provisioned L3VPN solutions have been proposed in recent years. The first is the Border Gateway Protocol/Multi-Protocol Label Switching (BGP/MPLS) VPN described in RFC 4364 and U.S. Pat. No. 6,339,595. The second is the Virtual Router based IP VPN described in the ietf draft “Network based IP VPN Architecture Using Virtual Routers”, http://www.ietf.org/internet-drafts/draft-ietf-I3vpn-vpn-vr-03.txt, March 2006.

Two issues have to be handled by a “provider provisioned” L3 VPN, such as that shown in FIG. 1. The first issue is that the addressing within VPN sites (e.g. the LANs 11, 12 shown in FIG. 1) may be such that their private address spaces overlap. The second issue is that P routers are not aware of VPN addressing and are not directly capable of routing traffic to a VPN internal address.

The first issue means that the IP header's destination field of the packet received from a customer is not enough to route the packet. Overlap is handled using different forwarding tables (Virtual Routing and Forwarding tables (VRFs)) for different VPNs and encapsulating (tunnelling) VPN data packets (using the inner header 19 shown in FIG. 1). Based on the inner header 19, the egress PE router PE 2 can look up the packet destination address in the appropriate VRF. In the BGP/MPLS VPN this inner header 19 is an MPLS label, while in the Virtual Router based VPN any encapsulation method can be used (e.g. IP-in-IP, IPSec, Generic Routing Encapsulation (GRE)). However, the main difference between these methods is how PE routers exchange routes of a particular VPN.

FIG. 2 is a schematic illustration of a BGP/MPLS VPN arrangement. Similar elements to those of FIG. 1 are represented with the same reference numerals. VPNs for two customers (#1 and #2) are shown. The ingress and egress PE routers PE1, PE 2 are connected to the CE routers CE1-CE4 (not shown in FIG. 2). Each PE router contains a VRF (#1, #2) for each VPN (#1, #2). BGP with Multiprotocol

Extensions (MP-BGP, described in RFC 2283) 21 is used to exchange routes for each VPN (#1 or #2). This involves exchanging the routes using the VPN-IPv4 address family. This address family contains, besides an IPv4 address field, a Route Distinguisher (RD) field which is different for each VPN. This ensures that, if the same address is used in several different VPNs, it is possible for BGP to carry several completely different routes to that address, one for each VPN. The relevant VRF is identified by an inner Label Switched Path (LSP) label 22 which is appended to the IP packet.

FIG. 3 is a schematic illustration of a Virtual Router (VR) based VPN arrangement. In this case, not only a VRF is allocated for each VPN, but a whole routing instance 31 that emulates all the functionality of a physical router. Routing information is exchanged between VRs of the same VPN using the same tunnels 32 as those used by VPN data flow. Therefore the forwarding tables of virtual routers can be populated using any standard routing protocol (e.g. BGP, Open Shortest Path First (OSPF), Intermediate System to Intermediate System (IS-IS)). However in order to enable a PE to dynamically discover the set of remote VRs which are in common VPNs, and in order to discover the connectivity between these VRs, BGP-4 multiprotocol extensions have also been proposed in “Using BGP as an Auto-Discovery Mechanism for VR-based Layer-3 VPNs”, http://www.ietf.org/nternet-drafts/draft-ietf-I3vpn-bgpvpn-auto-08.txt, September 2006. These are similar to the BGP/MPLS VPN solution discussed above.

The second issue that has to be handled by a provider provisioned L3 VPN is that P routers should not maintain VPN site related routing information, i.e. packets cannot be routed based on VPN sites' private IP addresses. Using only the inner header for this purpose, the number of routing states in P routers would be related to the number of VPNs and the number of their sites. In order to overcome this, in both VPN solutions an outer tunnel 23 is proposed, and any encapsulation method can be used for this purpose (e.g. MPLS, IP-in-IP, GRE, IPSec).

It is expected that future transport networks will rely on low cost Ethernet transport—i.e. the provider network routers will be connected with Ethernet interfaces. Such a scenario could be the basis of fixed/mobile access networks with an Ethernet aggregation network, and Ethernet is even under consideration as a backbone transport solution. When PE routers are directly connected using an Ethernet network this can lead to a special case of the Virtual Router based VPN. In this case the outer header is not needed and the virtual LAN (VLAN) tag (defined in IEEE 802.1Q) can be used as an inner header in order to separate the VPNs in the provider's network. This architecture can be achieved, for instance, with current Juniper or Cisco products (http://www.avaya.com/master-usa/en-us/resource/assets/applicationnotes/vrf juncis.pdf) using the so-called Multi-VRF feature (“Building Trusted VPNs with Multi-VRF”, http://www.foundrynet.com/pdf/wp-vpn-multi-vrf.pdf).

FIG. 4 illustrates an arrangement in which the provider network routers PE1, P3, PE2 are connected with Ethernet interfaces, but where the PE routers PE1, PE2 are not directly connected using Ethernet. In this case the data and routing use the same tunnel 32, as before. Each router PE1, PE2, P3 includes a VLAN sub-interface 33 for each VPN.

In an Ethernet network such as that shown in FIG. 4, different VLANs form different IP subnets, and IP routers are used for inter-VLAN communications. In order for the ingress router PE1 to achieve VLAN tagging, the different virtual sub-interfaces 33 have to be configured. These sub-interfaces 33 have different network addresses, which depend on the subnet (VLAN) each belongs to. Based on the destination address, packets are directed to the appropriate virtual sub-interface 33 inside the router PE1, which in turn encodes the packets with the appropriate VLAN tag.

The VLAN tag then needs to be preserved in the provider network. The router P3 inside the provider network is configured to preserve the VLAN tag by the configuration of the VLAN sub-interfaces 33. It is also required to maintain VPN related routing information.

In the egress router PE2, both the VLAN tag and the external IP header are detached. Using the VLAN tag, the egress router PE2 looks up the appropriate VRF in order to find the correct VPN site based on packet IP destination address. This is achieved using the VLAN sub-interfaces 33 attached to different VRFs.

Thus the most commonly used VPN technology, BGP/MPLS VPN, relies on MPLS functionality in the PE routers. The alternative is to use a virtual router approach, which eliminates the LSP requirement for the inner header. However, it has scalability limitations since, for each VPN, a different routing instance 31 (a different routing daemon) runs in the PE router. Moreover it requires the manual configuration of the inner tunnels 32 (an IP-in-IP or a GRE tunnel needs the configuration of two tunnel endpoint virtual interfaces, both of them with at least 3 parameters), which enormously increases the configuration complexity compared to BGP/MPLS VPN. The VLAN tag based solution does not require the configuration of bi-directional tunnels, but suffers from similar scalability limitations to the virtual router concept. In addition, if the PE routers are not directly connected using Ethernet, it requires per-VPN virtual router functionality, including configuration of VLAN sub-interfaces on P routers.

### SUMMARY

In accordance with one aspect of the present invention there is provided a method for setting up a VPN in a backbone network having a plurality of PE routers for controlling the transfer of IP traffic to and from CE routers in satellite networks. In a PE router, a VRF is configured for the VPN and populated with local routes for the VPN. A VLAN identifier is assigned for the VPN. It may be that the assignment of the VLAN identifier to the VPN is unique to this particular PE router, or it may be the VLAN identifier is used to identify the VPN in all PE routers, in which case it is determined, using a predetermined mapping algorithm, from a RD for the VPN. A local route with the VPN RD is advertised to other PE routers in the backbone network. If the VLAN identifier is unique to the PE router, the advertisement also includes the VLAN identifier itself. If the VLAN identifier is the same for the VPN in all PE routers, the advertisement includes an implicit NULL label.

The local routes may be populated from a customer site which is directly connected to the PE router. This process may be carried out manually or dynamically using standard routing protocols.

Other PE routers in the backbone network can then receive the advertised local route and populate local VRFs with the local route. The advertisement may be carried out using Border Gateway Protocol with Multiprotocol Extensions “MP-BGP”

Thus the present invention, at least in preferred embodiments, provides an alternative to VLAN tag based Virtual Router based VPN, but is based on the MP-BGP protocol instead of the virtual router concept. It does not require P routers to handle VPN related routing information, and does not require configuration of VLAN sub-interfaces.

Preferably the PE router encapsulates IP packets relating to the VPN before forwarding the encapsulated packets through the backbone network. The encapsulation may be carried out using IP-in-IP, IPSec or GRE, for example.

The encapsulation may include the addition of an encapsulation header to encapsulated IP packets, the encapsulation header including the address of an egress

PE router as a destination address. An Ethernet MAC header may also be added to each packet (regardless of whether or not it is a packet relating to the VPN). For those packets which do relate to the VPN, a VLAN tag including the VLAN identifier may be added to the Ethernet MAC header.

If an encapsulated packet is received at a P router in the network, the VLAN identifier may be extracted from the VLAN tag included in the Ethernet MAC header and locally saved in a local variable. The next-hop destination for the packet may be identified, based on the destination address. The locally saved VLAN identifier may then be inserted into a new Ethernet MAC header before the encapsulated packet is forwarded through the backbone network. In one embodiment the P router maintains a list of VLAN identifiers which should be preserved, and only locally saves the VLAN identifier in the local variable if it is on the list.

If an encapsulated packet is received at an egress PE router, the VLAN identifier may be extracted from the VLAN tag included in the Ethernet MAC header and locally saved in a local variable. The packet may then be decapsulated. An appropriate VRF may then be identified from the locally saved VLAN identifier, and a next-hop CE address identified from the appropriate VRF. The packet may then be forwarded to the CE address. The PE router may also maintain a list of VLAN identifiers which should be preserved, and only locally save the VLAN identifier in the local variable if it is on the list.

In accordance with a second aspect of the present invention there is provided a PE router for controlling the transfer of IP traffic between a backbone network and CE routers in satellite networks. The PE router comprises a processor arranged to configure a VRF for a VPN, populate the VRF with local routes for the VPN and assign a VLAN identifier for the VPN. The VLAN identifier may be identify the VPN in the PE router only, or may be the same in all PE routers, in which case it is determined from a VPN RD using a predetermined mapping algorithm. The PE router also comprises a storage medium for storing the VRF, and a transmitter arranged to advertise a local route with the VPN RD to other PE routers in the backbone network. If the VLAN identifier is unique to the PE router, the advertisement also includes the VLAN identifier itself. If the VLAN identifier is the same for the VPN in all PE routers, the advertisement includes an implicit NULL label.

In accordance with a third aspect of the present invention there is provided a PE router for controlling the transfer of IP traffic between a backbone network and CE routers in satellite networks. The PE router comprises a receiver arranged to receive, from another PE router in the backbone network, an advertisement including a local route for a VPN and a VPN RD. The advertisement will also contain either a VLAN identifier or an implicit NULL label. The PE router also comprises a processor. If the advertisement contains an implicit NULL label, the PE router is arranged to determine the VLAN identifier for the VPN from the VPN RD using a predetermined mapping algorithm. The processor is also arranged to populate a VRF for the VPN with the local route. The PE router also comprises a storage medium for storing the VRF.

In accordance with a fourth aspect of the present invention there is provided a network for supporting a VPN. The network comprises a backbone network comprising a plurality of PE routers, and a plurality of satellite networks, each having at least one CE router operatively connected to a PE router in the backbone network. An ingress PE router maintains a VRF for the VPN, the VRF being populated with local routes for the VPN. A VLAN identifier is assigned for the VPN. If the VLAN identifier is the same for all PE routers then it may be determined from a VPN RD using a predetermined mapping algorithm. A local route with VPN RD is advertised to other PE routers in the backbone network. If the VLAN identifier is unique to the ingress PE router then the advertisement also includes the VLAN identifier. If the VLAN identifier is the same for the VPN in all PE routers then the advertisement also includes an implicit NULL label.

Where a message is stated as being sent from or to a particular node, for example, it is to be understood that this is intended as including the case where the message is not sent directly from or to the particular node, but via other nodes as well.

According to a fifth aspect of the present invention there is provided apparatus for use in a network, the apparatus comprising means for performing a method according to the first aspect of the present invention.

According to a sixth aspect of the present invention there is provided a program for controlling an apparatus to perform a method according to the first aspect of the present invention or which, when loaded into an apparatus, causes the apparatus to become an apparatus according to the fourth aspect of the present invention. The program may be carried on a carrier medium. The carrier medium may be a storage medium. The carrier medium may be a transmission medium.

According to a seventh aspect of the present invention there is provided an apparatus programmed by a program according to the sixth aspect of the present invention.

According to an eighth aspect of the present invention there is provided a storage medium containing a program according to the sixh aspect of the present invention.

### BRIEF DESCRIPTION OF THE DRAWINGS

FIG. 1 is a schematic illustration of a provider provisioned L3 VPN architecture;

FIG. 2 is a schematic illustration of a BGP/MPLS VPN;

FIG. 3 is a schematic illustration of a virtual router based VPN;

FIG. 4 is a schematic illustration of a VLAN tag based virtual router based architecture;

FIG. 5 is a schematic illustration of a VLAN tag based VPN which is not based on virtual routers;

FIG. 6 illustrates the Multiprotocol Extension attribute for a BGP/MPLS VPN;

FIG. 7 illustrates the Multiprotocol Extension attributes for mapping a VLAN id unique to a particular PE router;

FIG. 8 illustrates the Multiprotocol Extension attributes for mapping when a given VLAN id is the same for a given VPN in all PE routers;

FIG. 9 is a flow chart illustrating the actions taken by an ingress PE router when a packet arrives from a customer;

FIG. 10 illustrates packet format between provider routers; and

FIG. 11 is a flow chart illustrating the actions taken by a P router and an egress P router when a packet is received.

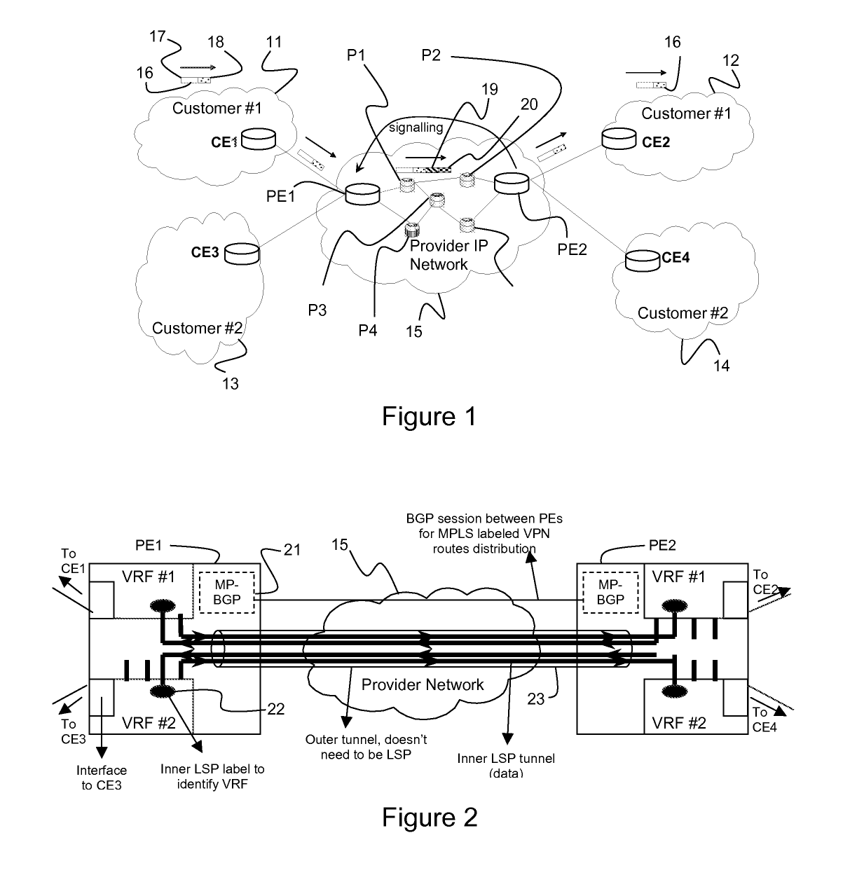

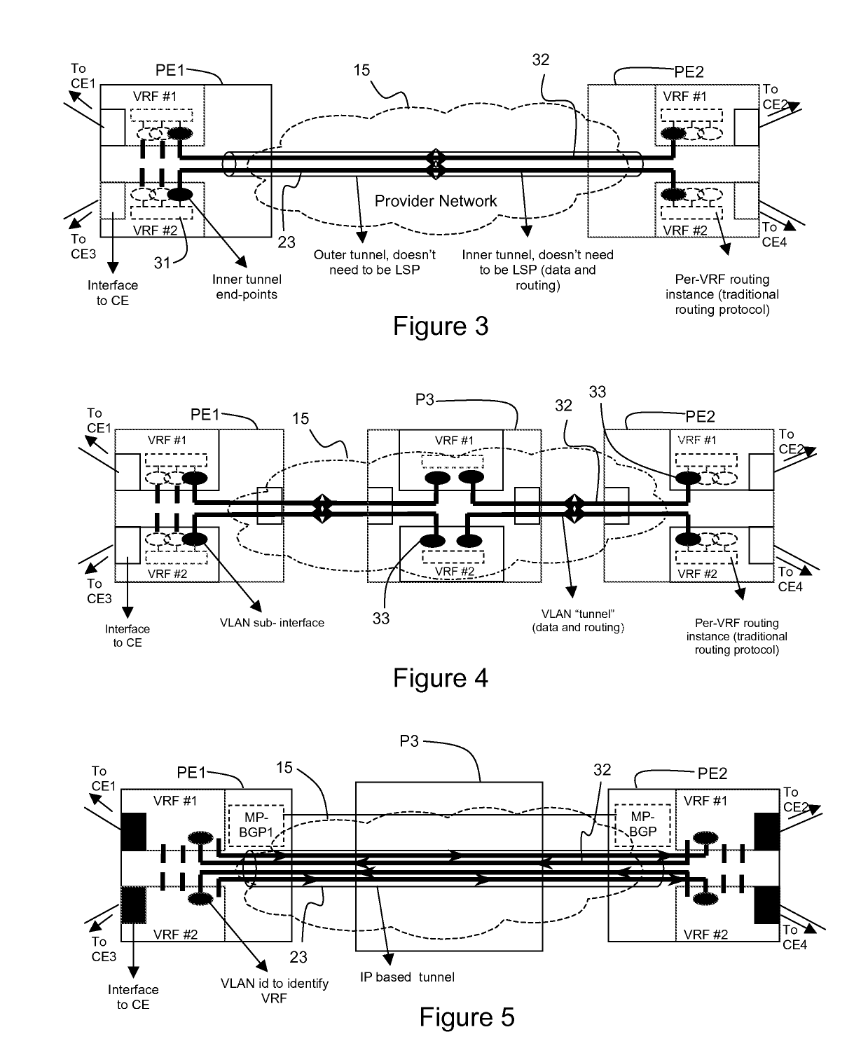

### DETAILED DESCRIPTION

FIG. 5 is a schematic illustration of a BGP-IP VPN architecture, As before, each PE router PE1, PE2 maintains one or more forwarding tables (VRF) for each VPN. In this example each PE router has a VRF #1 and VRF #2 for the VPNS #1 and #2 respectively. This is similar to the situation for the BGP/MPLS VPN approach described above. Each VRF is populated with customer routes using manually entered static routes using e.g. RIPv2, OSPF or eBGP, and the local customer routes are advertised to other PE routers using the MP-BGP protocol, as described in RFC 2283.

In the BGP/MPLS VPN approach previously described, the advertisement messages of the MP-BGP protocol contain MPLS labelled VPN-IPv4 routes. MP-BGP for BGP/MPLS VPN advertises the following information:
PE loopback address (as the next-hop address)
VPN-IPv4address prefix 64, consisting of:
   Route distinguisher, which includes an ID of the VPN customer (8 bytes)
   IP address prefix (4 bytes)
MPLS label (which identifies the VPN-IPv4 address prefix or the VRF)

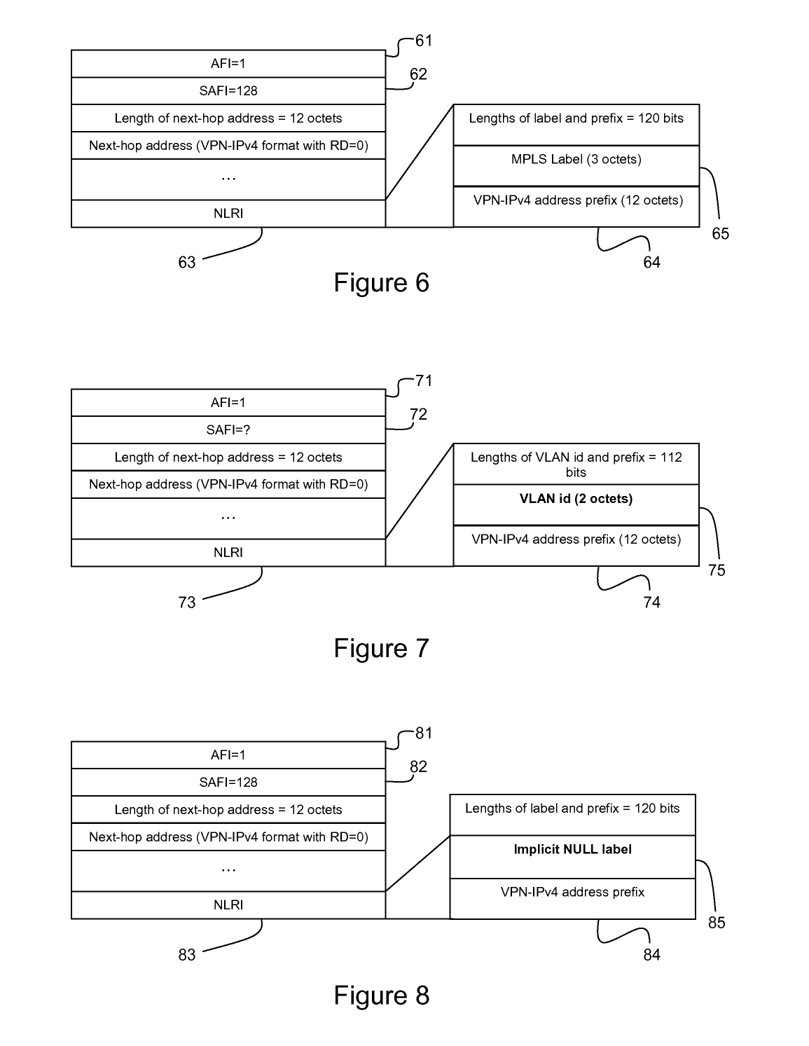

FIG. 6 illustrates how this information is included in the Multiprotocol extension optional attribute (RFC 2283). The Address Family Identifier (AFI) field 61 is set to 1 and the Subsequent Address Family Identifier (SAFI) field to is set to 128. These values confirm that the Network Layer Reachability Information (NLRI) field 63 contains a VPN-IPv4 address 64 labelled using an MPLS label 65 (RFC 3107).

Using the system currently proposed, a VLAN id is associated with each VPN, and thus each VRF. It is necessary to map the VPN id to the VLAN id, and the way this is achieved will depend on whether or not the same VLAN id is associated with a particular VPN in all of the PE routers. Two exemplary mapping systems are therefore described.

The first mapping system applies to the situation in which different VLAN ids are assigned in different PE routers to the same VPN. This is illustrated with reference to FIG. 7. Instead of the MPLS label 65, the MP-BGP protocol is used to advertise the VLAN ids between different PE routers. In a PE router the VLAN id associated with each VRF must be unique. The VLAN ids are advertised in the PE routers PE1, PE2, but not the P routers P1-P4, in the providers' backbone.

The information to be advertised is the following:
PE loopback address (as the next-hop address)
VPN-IPv4 address prefix 74, consisting of:
   Route distinguisher (8 bytes)
   IP address prefix (4 bytes)
VLAN id 75 (12 bits) (which identifies the VRF instance to be used for this specific VPN in this PE).

It will also be noted from FIG. 7 that a new SAFI code 71 and a new NLRI format 73 will be required.

The advantage of this type of mapping is that a single PE node can serve a maximum of 4096 VPNs (due to the 12 bit constraint on the VLAN ids), but the total number of VPNs in the provider network can exceed the maximum number of VLAN ids of any given single PE node.

The second mapping system applies to the situation in which the same VLAN id is assigned in all PE routers to the same VPN—i.e. each VPN has a unique VLAN id used by all PE routers. In this case there is no need to advertise these values between PE routers. One way of ensuring consistent VLAN ids is simply to map the VPN id directly to the VLAN id in each PE router. As in the BGP/MPLS VPN solution, the VPN id is encoded in the 8-byte of Router Distinguisher (RD) field. Each VRF has the RD (VPN id) set, thus the ingress PE router PE1 can encode directly this value in the VLAN tag. In order to avoid standardization, the Multiprotocol Extension attribute for BGP/MPLS VPN can be used, but with an implicit NULL label. This is illustrated with reference to FIG. 8.

The information to be advertised is the following:
PE loopback address (as the next-hop address)
VPN-IPv4 address prefix 84, consisting of:
   Route distinguisher (8 bytes)
   IP address prefix (4 bytes)
Implicit NULL label 85.

This mapping method is again constrained so that each PE can serve a maximum of 4096 VPNs. In this case, since the VLAN id for each VPN is the same in all PE routers, the number of VPNs in the network is also restricted to 4096. However, there is no requirement for definition of a new NLRI 83. Alternatively, a new NLRI format, containing only the VPN-IPv4 address prefix, could be defined, but this would require the standardisation of a new SAFI code.

The forwarding behaviour in ingress PE routers, P routers, and egress PE routers will now be described.

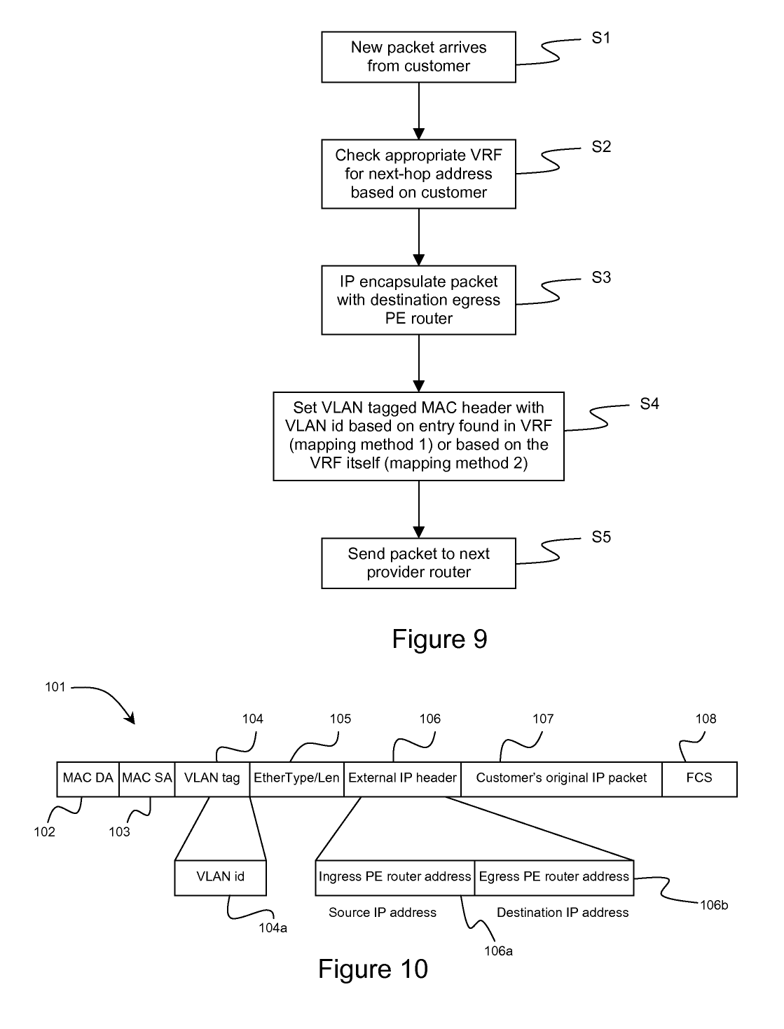

A VLAN tagging mechanism is proposed in ingress PE routers which does not require virtual sub-interfaces or the configuration of different IP subnets. The VLAN tagging is similar to the way a Label Edge Router (LER) encodes LSP labels. The mechanism is illustrated in FIG. 9, and includes the following steps (assuming that the VRFs have been populated with remote VPN routes based on the new MP-BGP messages):

S1: A new packet arrives at the ingress router PE1 from a customer edge router CE1.

S2: Based on the customer from which the packet has come, and the VPN to which the packet belongs, the ingress router PE1 chooses a VRF in order to find the next-hop address based on the packet's destination address.

S3: If the next-hop address is a different PE router, the packet is IP encapsulated, with the external header containing the loopback address of the egress PE router PE2.

S4: A VLAN tag, containing the VLAN id, is inserted into the Ethernet Media Access Control (MAC) header of the IP packet. If the first mapping method described above is used, the “find route” entry from the VRF forwarding table will also contain the VLAN id. If the second mapping method described above is used, the VLAN id is based directly on the VRF itself.

S5: The packet is sent to the next provider router P3.

The inclusion of the VLAN id in the IP encapsulated packet is illustrated in FIG. 10, which shows an IP packet 101 having a destination MAC address 102, a source MAC address 103, a VLAN tag 104 including the VLAN id 104a, an Ethertype field 105, an external (encapsulation) IP header 106 including the address 106a of the ingress PE router PE1 as a source IP address and the address 106b of the egress PE router PE2 as a destination IP address, the original IP packet 107 as received from the customer, and a Fram Check Sequence (FCS) 108. It will be noted that the VLAN tag is included in the Ethernet MAC portion of the header which is added to all packets, not only those which are part of a VPN. This reduces the overhead required, as no additional header needs to be added.

Once the packet has been sent into the provider network by the ingress router PE1, the VLAN tag must be preserved in the provider network. In order to avoid the configuration of VLAN sub-interfaces and maintenance of VPN related routing information in P routers, a new function is proposed in P routers to preserve the VLAN tag. This function should ensure (if activated) that each P router (e.g. P3) preserves the VLAN tag in a packet when it forwards the packet.

In order to keep the traditional, virtual-interface based VLAN handling, this can be achieved by setting a range of VLAN ids (known as the “VLAN preserving list”), for which the VLAN tags are preserved. For VLAN ids which are not in this range, the packets are processed traditionally.

In the egress router PE2, both the VLAN tag and the external IP header is detached. Using the VLAN tag, the egress router PE2 looks up the appropriate VRF in order to find the correct VPN site based on packet IP destination address. In order to avoid the use of VLAN sub-interfaces attached to different VRFs, a new function is proposed for use by egress PE routers to detach the VLAN tag and send the packet to the appropriate VRF without requiring VLAN sub-interfaces.

In order to keep the traditional, virtual-interface based VLAN handling, this can again be achieved by setting a range of VLAN ids, for which this function operates. For VLAN ids that not in this range, the packets are processed traditionally.

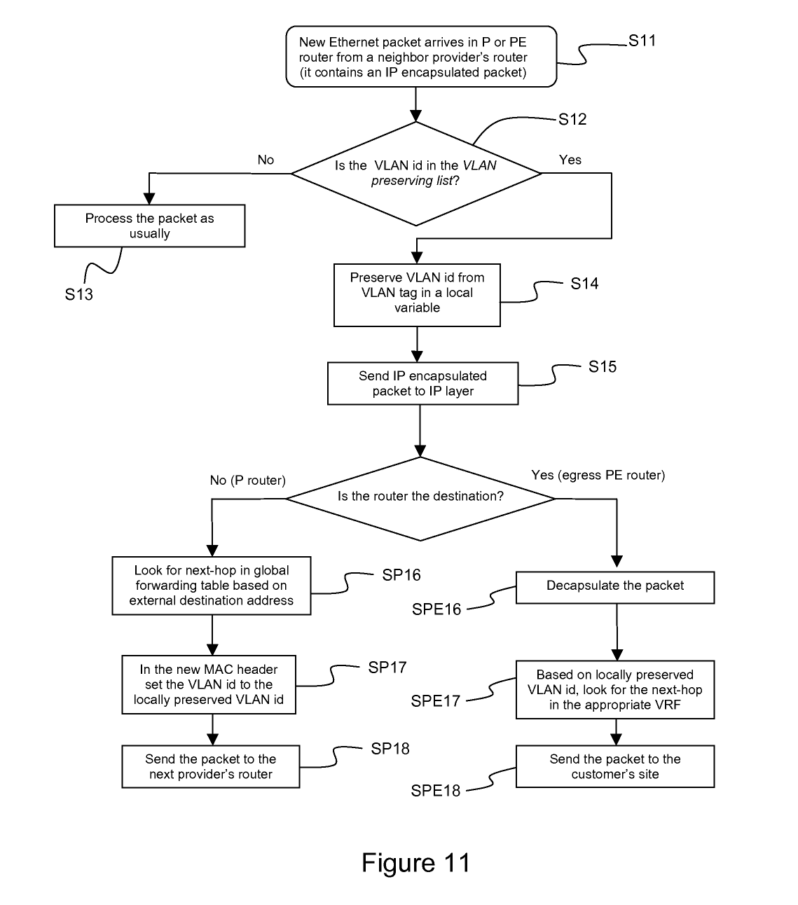

The operation of P routers and PE routers can be better understood with reference to FIG. 11, as follows:

S11: A new IP encapsulated packet arrives in a provider router (P router or PE router) from a neighbouring router in the provider network.

S12: A check is made to see if the VLAN id is in the VLAN preserving list of VLAN ids which must be preserved.

S13: If the VLAN id is not in the VLAN preserving list it is processed as normal.

S14: If the VLAN id is in the VLAN preserving list, it is preserved in a local variable.

S15: The IP encapsulated packet is sent to the IP layer.

If the router is not the destination of the packet (i.e. the router is a P router), the packet is then processed as follows:

SP16: The next-hop address is found from the global forwarding table, based on the external destination address.

SP17: A new MAC header is generated, in which the VLAN id is set to the locally preserved VLAN id.

SP18: The packet is sent to the next router in the provider network.

If the router is the destination address of the packet (i.e. it is an egress PE router), the packet is processed as follows:

SPE16: The packet is decapsulated.

SPE17: The next-hop address (in the customer's network) is identified by looking in the appropriate VRF, identified by the locally preserved VLAN id.

SPE18: The packet is sent to the customer's site.

If VLAN ids are used to differentiate VPNs at PE edge routers, these VLAN IDs must not be used in the interior of the network for local purposes, since the VLAN tags added to the packet need to be preserved through the network. Furthermore, an encapsulated packet may pass multiple Ethernet segments between the ingress and the egress PEs, but VLAN tags in the VLAN preserving list must not be used for local purposes on any Ethernet segment.

If there is a requirement for one of the reserved VPN related VLAN IDs to be used locally on an Ethernet segment, then the router at the beginning of that segment must prepend a locally valid VLAN id with Q-in-Q encapsulation as specified in the 802.1ad standard. In this way, the VLAN tag in the external Q header will be used. The router at the end of the Ethernet segment must decapsulate the external Q header and must forward the packet preserving the internal VLAN tag.

If Q-in-Q encapsulation is used between ingress and egress PEs, the number of potential VPNs can be extended from 4096 to 4096×4096. This requires that P routers preserve both Q headers, and that the egress PE router decides about the proper VRF based on both Q headers.

Previous L3 VPN solutions which use VLAN tags instead of MPLS labels are based on the virtual-router concept, either on PE and P routers. Moreover the VLAN handling mechanism in previously known routers requires the configuration of VLAN sub-interfaces. Using the arrangement described, VLAN tag based L3 VPN can be achieved without virtual-routers and VLAN sub-interface configuration. L3 VPN can therefore be provided in networks where provider's routers are connected through Ethernet networks with the same configuration simplicity as in the BGP/MPLS VPN. The attaching/detaching of VLAN tags is made in a similar way as in the MPLS networks, except that a VLAN tag encoded in ingress PE routers is not changed in P routers.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

It will also be appreciated by the person of skill in the art that various modifications may be made to the above-described embodiments without departing from the scope of the present invention as defined by the appended claims.

1. A method for setting up a Virtual Private Network (VPN) in a backbone network in which provider network routers are connected with Ethernet interfaces, the network having a plurality of Provider Edge (PE) routers for controlling the transfer of IP traffic to and from Customer Edge (CE) routers in satellite networks, the method comprising:
in a PE router, configuring a Virtual Routing and Forwarding (VRF) Table for the VPN and populating the VRF table with local routes for the VPN;
determining a Virtual LAN (VLAN) identifier for the VPN from a VPN Route Distinguisher (RD) using a predetermined mapping algorithm: and
advertising a local route with the VPN RD and an implicit NULL label to other PE routers in the backbone network.

2. The method of claim 1, wherein the VLAN identifier is the same as the VPN RD.

3. The method of claim 1, wherein another PE router in the backbone network receives the advertised local route with the VPN RD and implicit NULL label, determines the VLAN identifier from the VPN RD using the predetermined mapping algorithm, and populates a local VRF table with the local route.

4. The method of claim 1 any procoding claim, wherein the backbone network further comprises Provider (P) routers between the PE routers for forwarding data within the backbone network, and wherein the PE router encapsulates IP packets relating to the VPN and adds an encapsulation header and an Ethernet Media Access Control “MAC” header to each IP packet before forwarding the encapsulated packets through the backbone network, the encapsulation header including the address of an egress PE router as a destination address and the Ethernet MAC header including a VLAN tag including the VLAN identifier.

5. A method for setting up and operating a Virtual Private Network (VPN) without using MPLS functionality in a backbone network in which provider network routers are connected with Ethernet interfaces, the network having a plurality of Provider Edge (PE) routers for controlling the transfer of IP traffic to and from Customer Edge (CE) routers in satellite networks and a plurality of Provider (P) routers between the PE routers for forwarding data within the backbone network, the method comprising:
in a PE router, configuring a Virtual Routing and Forwarding VRF Table for the VPN and populating the VRF table with local routes for the VPN;
assigning a Virtual LAN (VLAN) identifier for the VPN;
advertising it local route with a VPN Route Distinguisher (RD) and the VLAN identifier to other PE routers in the backbone network;
encapsulating IP packets relating to the VPN;
adding an encapsulation header and an Ethernet Media Access Control (MAC) header to each IP packet the encapsulation header including the address of an egress PE router as a destination address and the Ethernet MAC header including a VLAN tag including the VLAN identifier; and
forwarding each encapsulated packet through the backbone network.

6. The method of claim 5, wherein another PE router in the backbone network receives the advertised local route with the VPN RD and VLAN identifier and populates a local VRF table with the local route.

7. The method of claim 4, further comprising
receiving an encapsulated packet at a P router;
extracting the VLAN identifier from the VLAN tag included in the Ethernet MAC header and locally saving the VLAN identifier in a local variable;
identifying a next-hop destination for the packet based on the destination address;
inserting the locally saved VLAN identifier into a new Ethernet MAC header; and
forwarding the encapsulated packet through the backbone network,

8. The method of claim 7, wherein the P router maintains a list of VLAN identifiers which should be presented, and only locally saves the VLAN identifier in the local variable if it is on the list.

9. The method of claim 4 further comprising:
receiving an encapsulated packet at an egress PE router;
extracting the VLAN identifier from the VLAN tag included in the Ethernet MAC header and locally saving the VLAN identifier in a local variable;
decapsulating the packet;
identifying an appropriate VRF from the locally saved VLAN identifier ;and identifying a next-hop CE address from the appropriate VRF; and
forwarding the packet to the CE address.

10. The method of claim 9, wherein the egress PE router maintains a list of VLAN identifiers which should be preserved and only locally saves the VU\N identifier in the local variable if it is on the list.

11. The method of claim 1, wherein the advertisement is carried out using Border Gateway Protocol with Multiprotocol Extensions MP-BGP.

12. A Provider Edge (PE) router for controlling the transfer of IP traffic between a backbone network, in which provider network routers are connected with Ethernet interfaces, and Customer Edge (CE) routers in satellite networks, the PE router comprising:
a processor arranged to configure a Virtual Routing and Forwarding (VRF) Table for a Virtual Private Network (VPN), populate the VRF table with local routes for the VPN and determine a Virtual LAN (VLAN) “VLAN” identifier for the VPN from a VPN Route Distinguisher (RD) using a predetermined mapping algorithm;
a storage medium for storing the VRF table; and
a transmitter arranged to advertise a local route with the VPN RD and an implicit NULL label to other PE routers in the backbone network,

13. The PE router of claim 12, arranged to encapsulate IP packets relating to the VPN and add an encapsulation header and an Ethernet Media Access Control (MAC) header to each IP packet before forwarding the encapsulated packets through the backbone network, the encapsulation header including the address of an egress PE router and the Ethernet MAC header including a VLAN tag containing the VLAN identifier.

14. A Provider Edge (PE) router for controlling the transfer of IP traffic between a backbone network, inside which provider (P) network routers are connected with Ethernet interfaces, and Customer EdgeCE routers in satellite networks, without the use of MPLS functionality, the PE router comprising:
a processor arranged to configure a Virtual Routing and Forwarding (VRF) Table for a Virtual Private Network (VPN), populate the VRF table with local routes for the VPN and assign a Virtual LAN (VLAN) identifier for the VPN;
a storage medium for storing the VRF table: and
a transmitter arranged to advertise a local route with a VPN Route Distinguisher (RD) and the VLAN identifier to other PE routers in the backbone network;
wherein the processor is configured to encapsulate IP packets relating to the VPN and add an encapsulation header and an Ethernet Media Access Control “MAC” header to each IP packet, the encapsulation header including the address of an egress PE router and the Ethernet MAC header including a VLAN tag containing the VLAN identifier;
and the transmitter is configured to forward the encapsulated packets through the backbone network.

15. The PE router of claim 12, arranged so that the advertisement is carried out using Border Gateway Protocol with Multiprotocol Extensions (MP-BGP).

16. A Provider Edge (PE) router for controlling the transfer of IP traffic between a backbone network, in which provider network routers are connected with Ethernet interfaces and Customer Edge (CE) routers in satellite networks, the PE router comprising:
a receiver arranged to receive, from another PE router in the backbone network, an advertisement including a local route for a Virtual Private Network (VPN), a VPN Route Distinguishes (RD) and an implicit NULL label;
a processor arranged to determine a Virtual LAN (VLAN) identifier for the VPN from the VPN RD using a predetermined mapping algorithm and populate a Virtual Routing and Forwarding (VRF) Table for the VPN with the local route; and
a storage medium for storing the VRF table,

17. The PE router of claim 16, arranged to:
receive an encapsulated IP packet relating to the VPN, the encapsulated IP packet including an Ethernet Media Access Control (MAC) header including a VLAN tag containing the VLAN identifier;
extract the VLAN identifier from the VLAN tag included in the Ethernet MAC header and locally save the VLAN identifier in a local variable;
decapsulate the packet;
identify the VRF table from the locally saved VLAN identifier and identify a nex hop Customer address from the VRF table; and
forward the packet to the Customer address.

18. A Provider Edge (PE) router for controlling the transfer of IP traffic between a backbone network, inside which provider network routers are connected with Ethernet interfaces, and Customer Edge (CE) routers in satellite networks, without the use of MPLS functionality, the PE router comprising:
a receiver arranged to receive, from another PE router in the backbone network, an advertisement including a local route for a Virtual Private Network (VPN), a VPN Route Distinguisher (RD) and a Virtual LAN (VLAN) identifier;
a processor arranged to populate a Virtual Routing and Forwarding (VRF) Table for the VPN with the local route; and
a storage medium for storing the VRF table:
wherein:
the receiver is configured to receive an encapsulated IP packet relating to the VPN, the encapsulated IP packet including an Ethernet Media Access Control (MAC) header including a VLAN tag containing the VLAN identifier;
the processor is configured to:
extract the VLAN Identifier from the VLAN tag included in the Ethernet MAC header and locally save the VLAN identifier in a local variable;
decapsulate the packet; and
identify the VRF from the locally saved VLAN identifier and identify a next-hop Customer address from the VRF table;
and the PE router further comprises a transmitter configured to forward the packet to the Customer address.

19. A network for supporting a Virtual Private Network (VPN), the network comprising:
a backbone network comprising a plurality of provider network routers connected with Ethernet interfaces, the network comprising a plurality of Provider Edge (PE) routers;
a plurality of satellite networks, each having at least one Customer Edge (CE) router operatively connected to a PE router in the backbone network; wherein:
an ingress PE router maintains a Virtual Routing and Forwarding (VRF) Table for the VPN, the VRF table being populated with local routes for the VPN;
a Virtual LAN (VLAN) identifier for the VPN is determined from a VPN Route Distinguisher (RD) using a predetermined mapping algorithm; and
a local route with the VPN RD and an implicit NULL label is advertised to other PE routers in the backbone network.

20. The network of claim 19, wherein an egress PE router is configured to receive the advertised local route with the VPN RD and implicit NULL label, determine the VLAN identifier from the VPN RD using the predetermined mapping algorithm, and populate a local VRF table with the local route.

21. The network of claim 19, wherein the ingress PE router is configured to encapsulate IP packets relating to the VPN and add an encapsulation header and an Ethernet Media Access Control (MAC) header to each IP packet before forwarding the encapsulated packets through the backbone network, the encapsulation header including the address of an egress PE router as a destination address and the Ethernet MAC header including a VLAN tag including the VLAN identifier.

22. A network for supporting a Virtual Private Network (VPN) without the use of MPLS functionality, the network comprising:
a backbone network comprising a plurality of provider (P) network routers connected with Ethernet interfaces, the network further comprising a plurality of Provider Edge (PE) routers;
a plurality of satellite networks, each having at feast one Customer Edge (CE) router operatively connected to a PE router in the backbone network, wherein:
an ingress PE router maintains a Virtual Routing and Forwarding (VRF) Table for the VPN, the VRF table being populated with local routes for the VPN;
a Virtual LAN (VLAN) identifier is assigned for the VPN;
a local route with a VPN Route Distinguisher (RD) and the VLAN identifier is advertised to other PE routers in the backbone network; and
the ingress PE router is configured to encapsulate IP packets relating to the VPN and add an encapsulation header and an Ethernet Media Access Control (MAC) header to each IP packet before forwarding the encapsulated packets through the backbone network, the encapsulation header including the address of an egress PE router as a destination address and the Ethernet MAC header including a VLAN tag including the VLAN identifier.

23. The network of claim 21, wherein an egress PE router is configured to receive the advertised local route with the VPN RD and VLAN identifier and populate a local VRF table with the local route.

24. The network of claim 19, wherein the advertisement is carried out using Border Gateway Protocol with Multiprotocol Extensions (MP-BGP).

25.-28. (canceled)
